(19) United States
(12) Patent Application Publication
(10) Pub. No.: US 2026/0257855 A1
(43) Pub. Date: Sep. 3, 2026

(54) SELF REGULATING HEATER IN AN INTERMEDIATE BULK CONTAINER

(71) Applicant: Caliente LLC, Fort Wayne, IN (US)

(72) Inventors: James T. Blake, Wolcottville, IN (US); Tyler W. Ambriole, Fort Wayne, IN (US); Michael R. Kelly, Fort Wayne, IN (US)

(73) Assignee: Caliente LLC, Fort Wayne, IN (US)

(21) Appl. No.: 19/652,293

(22) Filed: Apr. 20, 2026

Related U.S. Application Data
(63) Continuation-in-part of application No. 17/862,822, filed on Jul. 12, 2022, now Pat. No. 12,606,365.
(60) Provisional application No. 63/223,296, filed on Jul. 19, 2021.

(51) Int. Cl. B65D 88/74; H05B 3/46

(52) U.S. Cl. CPC B65D 88/744; B65D 88/748; H05B 3/46; B65D 2588/125; B65D 2590/043; H05B 2203/003; H05B 2203/02; H05B 2203/035

(57) ABSTRACT

A storage container includes at least one internal compartment comprising a material and defining a volume; a first heating element positioned within the volume; and an electrical power source configured to supply electrical power to the first heating element. The first heating element is at least partially made of a positive temperature coefficient resistant material, the heat from the first heating element being largely transferred to the material.

### CROSS REFERENCE TO RELATED APPLICATIONS

This is a continuation-in-part of U.S. Patent Application Serial No. 17/862,822 entitled " SELF REGULATING HEATER IN AN INTERMEDIATE BULK CONTAINER,” filed July 12, 2022, which is incorporated herein by reference. U.S. Patent Application Serial No. 17/862,822 is a non-provisional application based upon U.S. Provisional Patent Application Serial No. 63/223,296, entitled " SELF REGULATING HEATER FOR AN INTERMEDIATE BULK CONTAINER,” filed July 19, 2021, which is incorporated herein by reference.

### BACKGROUND OF THE INVENTION

### 1. Field of the Invention

The present invention relates to storage containers having one or more internal compartments with a heating element.

### 2. Description of the Related Art

An Intermediate Bulk Container (IBC) is used in a variety of applications to transport various products across the globe. In one application the IBC is fitted with a heater and a bladder containing a solid (or semi-solid material) that when heat is applied undergoes a phase change to transfer the solid into a flowable material. Typical applications are the shipment of materials for food preparation where, for example essential fats, may be shipped in a semi solid state and phased changed to flowable material for mixing and processing.

An IBC fitted with a heater typically has an exterior container box with dimensions, which typically approximate 40” x 45” x 37”, including an onsite constructed lid, a bladder, fitted with an integral inlet and outlet valve, and a heater.

The prior art heater construction utilized in an IBC is what is classified as a fixed resistance heater (i.e., resistance is relatively constant regardless of temperature) encapsulated between two materials (typically a piece of cardboard and aluminum foil). The fixed resistance heater is controlled by two thermostats. One thermostat serves as a temperature control device (sensing the temperature of the fluid and controlling an electrical connection between the fixed resistance heater and an electrical power source) and the second thermostat serves as an over-temperature safety device to disconnect the electrical heater from the electrical power source when the temperature exceeds a selected safety temperature.

The use of a fixed resistance heater in an IBC has several disadvantages, including:

Thermal Runaway – It is known that the current fixed resistance heater construction can be put in an environment in which a thermal runaway can occur which could lead to a fire hazard. If the mass contained within the bladder is not distributed evenly across the heater and in intimate contact with the sensing devices this can cause a failure mode where one section of the heater may have a thermal runaway resulting in a fire. This failure mode is partially contributed to by the unevenly distributed load but also to the inherent flaws of a fixed resistance heater within an IBC both in the localized sensing of the temperature control device and the physics associated with a fixed resistance heater which provides constant power regardless of the environment it is in.

Energy Efficiency – Fixed resistance heating systems within an IBC are not energy efficient since their energy consumption is fixed across the duration of the heat up cycle.

Reliability, Predictability and Consistency – A significant limitation of fixed resistance heating systems is the variance that is inherent within the manufacturing of the control devices (thermostats) typically used in this application. The thermostats often have a hysteresis which results in unpredictable and unreliable performance between devices. The inconsistencies in control devices can result in inconsistent time to an ideal temperature between various IBCs and can result in higher than desired temperatures for the mediums being heated.

What is needed in the art is reliable, economical way of controlling the temperature in a storage container.

### SUMMARY OF THE INVENTION

The present invention provides a method and an apparatus for heating a material in a storage container.

The invention in one form is directed to a method for establishing and/or maintaining a desired temperature of a material in an intermediate bulk container including the steps of positioning a heater element in at least partial contact with a material container containing the material within the intermediate bulk container; and applying an electrical power source to the heater element, wherein the heater element is at least partially made of a positive temperature coefficient resistant material, the heat from the heater element being largely transferred to the material in the material container.

The invention in another form is directed to a method of heating a material in an intermediate bulk container including the steps of positioning a first heater element beneath a material container containing the material within an intermediate bulk container; and applying an electrical power source to the heater element, wherein the heater element is at least partially made of a positive temperature coefficient resistant material, the heat from the heater element being largely transferred to the material in the material container.

The invention in yet another form is directed to a heating system for use in in an intermediate bulk container including a first heater element positioned beneath a material container containing a material within the intermediate bulk container; and an electrical power source suppling electrical power to the heater element, wherein the heater element is at least partially made of a positive temperature coefficient resistant material, the heat from the heater element being largely transferred to the material in the material container.

The invention in yet another form is directed towards a storage container including at least one internal compartment comprising a material and defining a volume; a first heating element positioned within the volume; and an electrical power source configured to supply electrical power to the first heating element. The first heating element is at least partially made of a positive temperature coefficient resistant material, the heat from the first heating element being largely transferred to the material.

The invention in yet another form is directed towards a method of warming an item placed in a storage container, the method including: placing the item in a compartment of the storage container; and supplying electrical power from an electrical power source to a first heating element disposed in the storage container to provide heat to the compartment, the first heating element being at least partially made of a positive temperature coefficient resistant material, the heat created by the first heating element being largely transferred to material of the compartment.

An advantage of the present invention is that heating elements in a storage container are self-regulating without the use of a thermostat.

Another advantage is that the heating elements have a defined temperature at which the electrical resistance substantially increases.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exploded perspective view of an intermediate bulk container with an embodiment of a heating system of the present invention;

FIG. 2 is a cross-sectional view of the intermediate bulk container of FIG. 1;

FIG. 3 is a comparison chart illustrating the temperature of the intermediate bulk container of FIGS. 1 and 2 of the heating system of the present invention and that of the prior art;

FIG. 4 is another comparison chart illustrating the power consumption of the heating system of the present invention relative to the prior art;

FIG. 5 is a chart illustrating a temperature coefficient of resistance of the present invention relative to the temperature;

FIG. 6 is a schematic block diagram illustrating components of the heating system of the present invention; and

FIG. 7 is a schematic view of a storage container provided according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

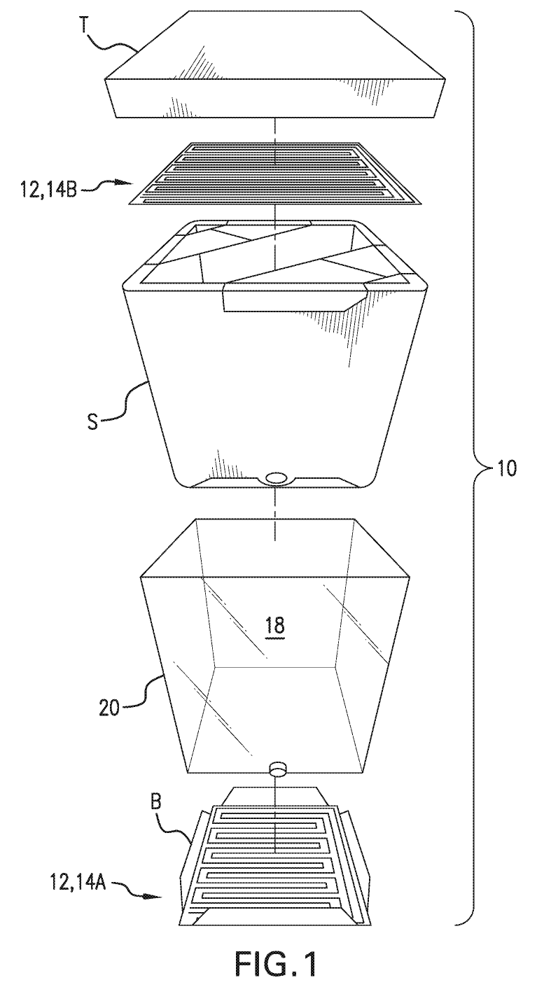

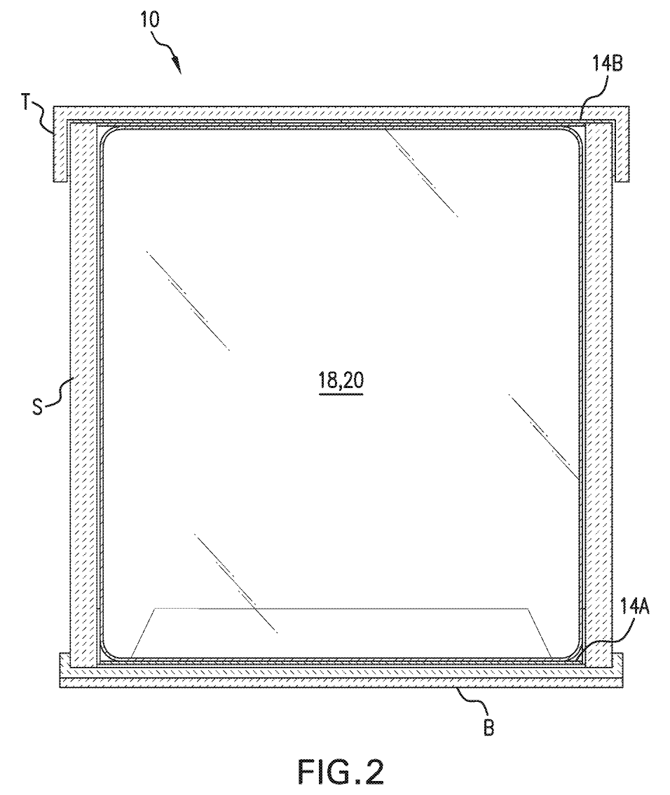

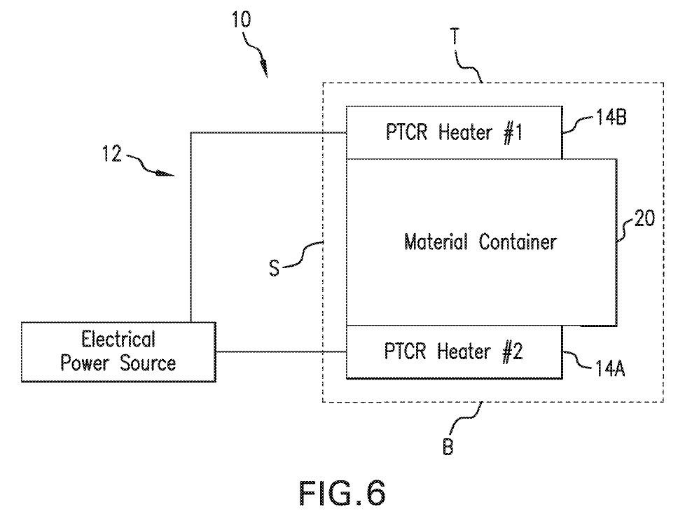

Referring now to the drawings, and more particularly to FIGS. 1 and 2, and with reference to FIG. 6, there is shown, in FIG. 1, an exploded perspective view of elements that form an Intermediate Bulk Containers (IBC) 10 of the present invention. IBC 10 utilizes a heating system 12 that includes at least one resistive heating element 14 (later referred to as heating elements 14A and 14B), which each having at least one positive temperature coefficient resistance (PTCR) portion that significantly increases in electrical resistance as the temperature of a material 18, contained in a material container 20 changes. The temperature of material 18 is typically reflective of the surface temperature of heating elements 14, due to the physical contact therebetween. The magnitude of the PTCR may vary depending on chemistry and/or physical properties of material 18 and the desired temperature that is to be maintained. The “safety” temperature set point at which an order of magnitude of resistance may increase is selected and can vary depending on the particular medium 18 being heated in order to optimize the performance of system 12 and maintain optimal temperatures of material 18 both pre and post phase change of material 18.

IBC 10 may be made of a multiple layer corrugated cardboard and may have at least one layer of insulation to reduce heat transmission therethrough. IBC 10, as illustrated in FIGS. 1 and 2, has a bottom portion B, a top portion T and a sidewall portion S. Material container 20 is positioned on top of a heating element 14A and is shown with a heating element 14B on top of material container 20. The placing of heating elements 14A and 14B help to reduce stratified temperatures in material 18 during shipment or storage during the heating process. It is also contemplated that additional heating elements 14 can be placed along any side of container 20 or even be made a part of container 20.

The present invention, when put into a condition where there is an unevenly distributed load of material 18, and/or variable heat conductivity between heating elements 14 and material 18, automatically sense an unevenly distributed thermal conductivity, which results in an increased temperature (where the conductivity is less), in the localized area, causing the resistance to rise in at least a part of heating element 14 that then serves to reduce and/or essentially shut off power consumption in that zone of a heating element 14. The energy consumption of system 12 is adjusted by way of the PTCR nature of elements 14 due to the temperature of material 18, which results in less energy usage over the warmup period of material 18.

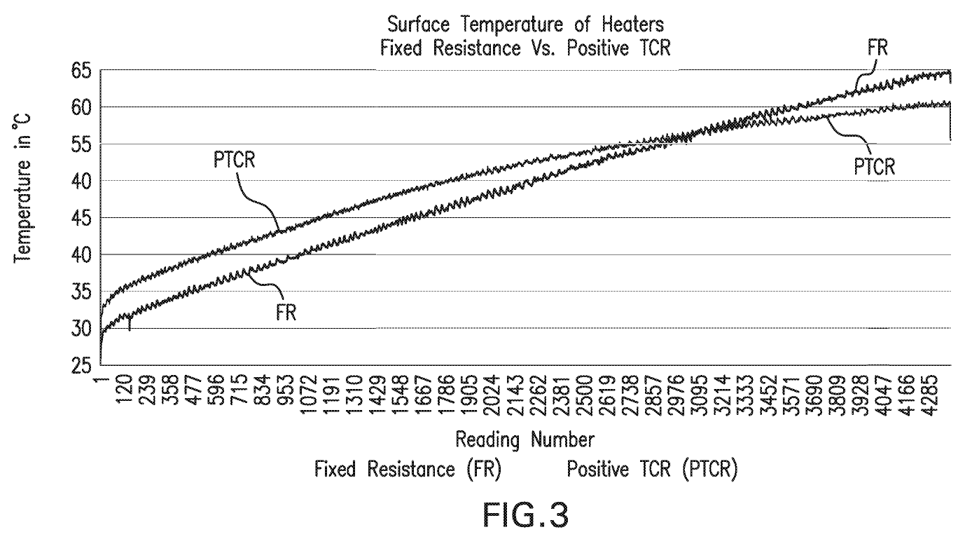

Now, additionally referring to FIG. 3, there is shown the continual rise in temperature of a fixed resistance heater versus Positive TCR heater elements 14 of the present invention which regulates itself to a specific temperature, for example 60°C. As can be seen, as time progresses, in the form of the reading numbers along the X axis, and as material 18 is warming, a prior art fixed resistance FR continues to increase in temperature until a thermostat turns off the FR power. In the event of an uneven thermal load on the FR heaters, the fixed resistance could potentially move into a thermal runaway operating mode. On the other hand, the Positive TCR heater 14 self-regulate regardless of thermal load/conductivity to material 18.

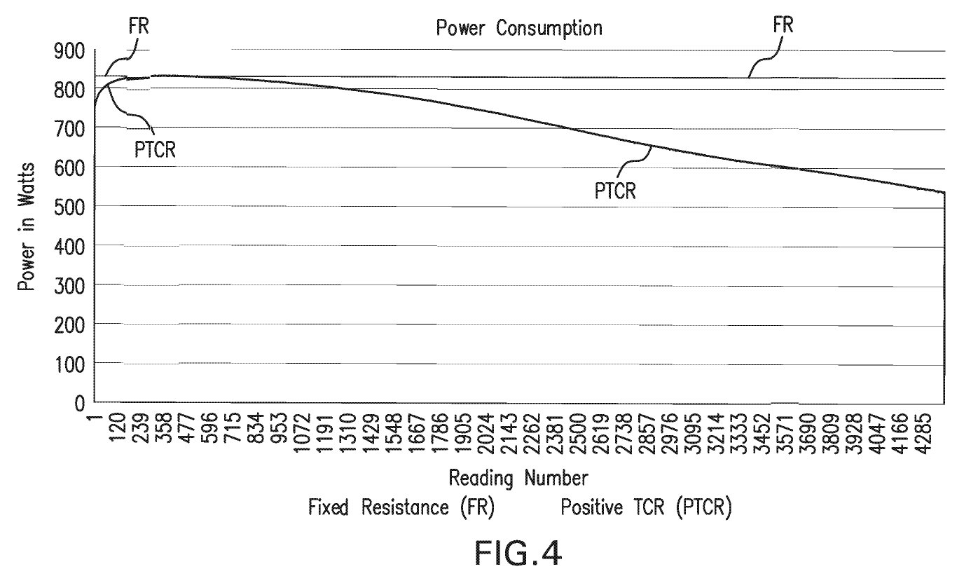

Now, additionally referring to FIG. 4, there is illustrated the electrical power consumption of PTCR heater 14 vs. fixed resistance heater FR. As can be seen, over time (as the reading numbers increase along the X-axis), the power consumption decreases for PTCR heaters 14, while the FR heaters continue until switched off by a controlling thermostat. This present invention leads to less power being consumed overall, since the power consumption is tapered off as heater 14 approaches the defined temperature based on the PTCR selection. Over the duration of this graph, the unit under test consumed 3.12MWhr of power using heaters 14. While the power consumption of the fixed resistance FR heater consumed 3.65MWhr of power, which represents approximately a 15% reduction in energy. It is anticipated that this gap would only grow wider over longer durations of comparison. The comparison presented in FIG. 4 used similar conduction paths for the heater elements for the FR and the PTCR comparison. In the event the heating elements are not properly installed, or have differing thermal conductivities to material 18, the differences will be even more pronounced, due to the distributed temperature control of heating elements 14 of the present invention.

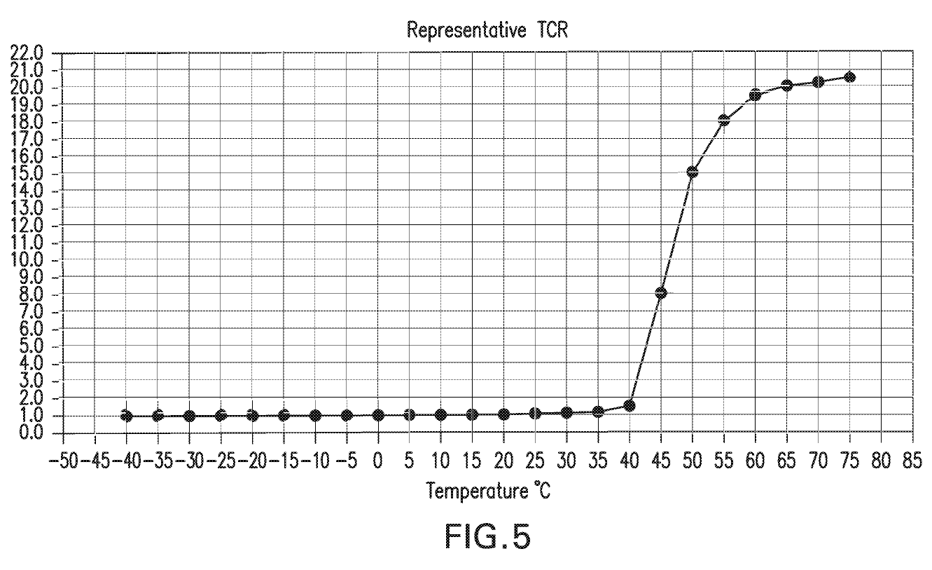

Now, additionally referring to FIG. 5 there is illustrated a PTCR heating element 14 with a defined PTCR value. This is in contrast with a fixed resistance heater FR which would have a flat TCR regardless of temperature. Utilizing a positive TCR heating element 14, the temperature at which the resistance increases dramatically can be varied depending on the chemistry and physical attributes of the heater technology utilized. The temperature coefficient, or slope of the resistance magnification (inclusive of magnitude of change) can vary as well depending on several factors such as chemistry, physical and granular properties of heating element 14.

Now, additionally referring to FIG. 6 there is shown a schematical block diagram of system 12 as it relates to IBC 10. As can be seen heaters 14 are in physical contact with material container 20 to ensure good thermal contact for efficient heat transfer. In the event material container 20 is only partially filled with material 18 the heat transfer from heating element 14B is in a self-regulated way - limited, so heating element 14B would reach the defined temperature more quickly than heating element 14A thereby causing heating element 14B to more quickly reduce the power consumption of heating element 14B. Heating elements 14 can be a single serial PTCR heating element or a series of parallel PTCR heating elements for more localized control. For example, heating element 14 can have many parallel PTCR circuits to thereby provide heat to material 18. If in the preparation of IBC 10, for example, heating element 14A is partially folded over, instead of causing a hot spot, as the prior art would, the local compensating control of the PTCR heating circuits 14 would compensate and release less heat due to more quickly reaching a localized temperature. As discussed herein, the present invention does not need a thermostatic control for operation and is self-regulating.

The positive temperature coefficient resistant material of heating elements 14 is selected to multiply the resistive value of heating elements 14 as a defined temperature is achieved. The heat transfer from heating element 14 is primarily to material container 20 and hence to material 18. Intermediate bulk container 10 is made of structural elements that have a lower thermal conductivity than a thermal conductivity of material container 20, to thereby direct the heat from heating elements 14 to material 18.

As noted in FIG. 6, heating elements 14A and 14B can be separately coupled to the electrical power source. With heating elements 14A and 14B being separately electrically self-regulating. Part of the advantages of the present invention are that the positive temperature coefficient resistant material has a selected temperature by which the electrical resistance thereof increases by at least a factor of 10, as part of the self-regulating nature of the PTCR material. As discussed, no thermostat need be connected between the electrical power source and the heating element to gain the advantages of the self-regulation.

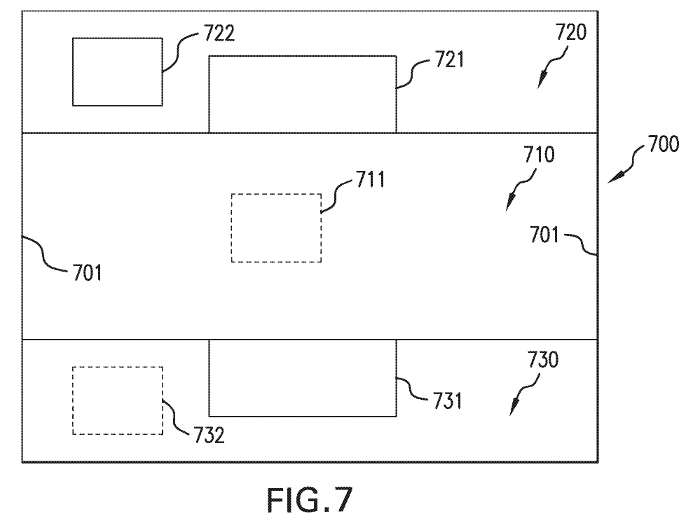

Referring now to FIG. 7, an exemplary embodiment of a storage container 700 provided according to the present invention is illustrated. The storage container 700 may be, for example, a food container that is shaped and configured to hold food items. The storage container 700 may be formed, for example, from a fabric that is woven or knit and is flexible. It should be appreciated, however, that the storage container 700 may be formed of other materials and fabric is merely one possible option. The fabric of the storage container 700 may have an insulating liner 701 applied thereto. The insulating liner 701 may be formed, for example, from a foil such as an aluminum or tin foil to retain heat within the storage container 700.

The storage container 700 includes at least one internal compartment, illustrated as three internal compartments 710, 720, and 730, that comprise a material and define a volume. The compartment(s) 710, 720, 730 may be formed of any desired material including, but not limited to, fabric, polymer, etc. The particular material used to form the compartment(s) 710, 720, 730 will vary based on the intended usage of the storage container 700 so it should be appreciated that many different materials can be used to form the compartment(s) 710, 720, 730.

A first heating element 721 is positioned within the volume of one of the compartments, illustrated as the compartment 720, which may be referred to as a “first heating compartment.” In embodiments where the storage container 700 has a single compartment, the first heating element may be placed within the single compartment. The first heating element 721 is at least partially made of a PTCR material, similarly to the previously described heating element 14. The previous description relating to the material and function of the heating element 14 is thus also applicable to the first heating element 721 and is not repeated further for brevity. An electrical power source 722 is configured to supply electrical power to the first heating element 721 in order to generate heat, which is largely transferred to the material of the internal compartment 720. By transferring the generated heat into the material of the compartment 720, the internal compartment 710, which may be sized and shaped to hold food items and can also be referred to as a “storage compartment,” can also be heated by the first heating element 721. Heating the storage compartment 710 can help keep food warm for a longer period of time, which may increase a consumer’s satisfaction with the food item and/or improve sanitation by keeping food items at a temperature that inhibits microorganism growth (the so-called temperature “danger zone”). The material of the compartment(s) 710, 720, 730 may thus be formed of a food-grade material, which may be, for example, high-density polyethylene (HDPE) and/or polyethylene terephthalate (PET) and/or any other material that complies with the Food and Drug Administration (FDA) standards for “food-grade.” It should be appreciated that while the term “food” is used herein, the term “food” should be also understood to mean “drink” as well and thus refers generally to items that are intended for consumption by an animal.

The storage container 700 may also include a second heating element 731 disposed in the internal compartment 730, which may be referred to as a “second heating compartment,” that is separated from the storage compartment 710 and the first heating compartment 720. The second heating element 731 may be formed similarly to the first heating element 721, i.e., at least partially made of a PTCR material. The heat from the second heating element 731 may also be largely transferred to material of the compartment(s) 710, 730, to heat the storage compartment 710 and any items (such as food) held within. In some embodiments, both heating elements 721, 731 are supplied with electrical power by the same power source, such as the first power source 722. In some embodiments, an optional second power source 732 is disposed in the second heating compartment 730 and is configured to supply electrical power to the second heating element 731. In some embodiments, the storage compartment 710 is disposed between the heating compartments 720, 730 to surround the storage compartment 710 with heated space and heat the storage compartment 710.

The present invention also provides a method of warming an item placed in the storage container 700. The method includes placing the item 711 in a compartment, such as the storage compartment 710, of the storage container 700 and supplying electrical power from the electrical power source 722 to the first heating element 721 to provide heat to the compartment 710. The method may also include supplying electrical power to the second heating element 731 disposed in the storage container 700 to provide further heat to the compartment 710. In some embodiments, the item 711 is a food item, which may or may not include a container that is separably removable from the storage container 700.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A storage container, comprising:
at least one internal compartment comprising a material and defining a volume;
a first heating element positioned within the volume; and
an electrical power source configured to supply electrical power to the first heating element, wherein the first heating element is at least partially made of a positive temperature coefficient resistant material, the heat created by the first heating element being largely transferred to the material.

2. The storage container of claim 1, wherein the at least one internal compartment comprises a first heating compartment in which the first heating element is disposed and a storage compartment materially separated from the first heating compartment.

3. The storage container of claim 2, wherein the at least one internal compartment further comprises a second heating compartment in which a second heating element is disposed and which is separated from the first heating compartment and the storage compartment.

4. The storage container of claim 3, wherein the storage compartment is disposed between the first heating compartment and the second heating compartment.

5. The storage container of claim 3, wherein the electrical power source is disposed in the first heating compartment or the second heating compartment and both the first heating element and the second heating element are supplied with electrical power by the electrical power source.

6. The storage container of claim 3, further comprising a second electrical power source configured to supply electrical power to the second heating element.

7. The storage container of claim 2, wherein the heating element and the second heating element are separately electrically self-regulating.

8. The storage container of claim 1, wherein the storage container comprises a fabric.

9. The storage container of claim 8, further comprising an insulating liner applied to the fabric.

10. The storage container of claim 1, wherein the first heating element is configured to react to an unevenly distributed thermal conductivity of the material in a zone by causing an electrical resistance of the first heating element to rise in the zone of the first heating element thereby reducing electrical power consumption in that zone of the first heating element.

11. The storage container of claim 1, wherein the positive coefficient resistant material is selected to multiply a resistive value as a defined temperature is achieved.

12. The storage container of claim 1, wherein the positive temperature coefficient resistant material has a selected temperature by which the electrical resistance thereof increases by at least a factor of 10.

13. The storage container of claim 1, wherein no thermostat is connected between the electrical power source and the first heating element.

14. The storage container of claim 1, wherein the material comprises a food-grade material.

15. A method of warming an item placed in a storage container, the method comprising:
placing the item in a compartment of the storage container; and
supplying electrical power from an electrical power source to a first heating element disposed in the storage container to provide heat to the compartment, the first heating element being at least partially made of a positive temperature coefficient resistant material, the heat from the first heating element being largely transferred to material of the compartment.

16. The method of claim 15, wherein the first heating element is disposed in a first heating compartment that is separated from the compartment in which the item is placed.

17. The method of claim 15, wherein the electrical power source is disposed in a compartment that is separated from the compartment in which the item is placed.

18. The method of claim 16, further comprising supplying electrical power to a second heating element disposed in the storage container to provide further heat to the compartment.

19. The method of claim 18, wherein the second heating element is disposed in a second heating compartment that is separated from the first heating compartment and the compartment in which the item is placed.

20. The method of claim 18, wherein the electrical power source supplies electrical power to both the first heating element and the second heating element.
